(19) United States
(12) Patent Application Publication
(10) Pub. No.: US 2026/0289697 A1
(43) Pub. Date: Sep. 24, 2026

(54) ARTIFICIAL INTELLIGENCE ASSISTED SYSTEM AND METHOD OF RESTAURANT ORDERING AND MANAGEMENT

(71) Applicant: Adam Denoto, Brook Park, OH (US)

(72) Inventor: Adam Denoto, Brook Park, OH (US)

(21) Appl. No.: 19/574,835

(22) Filed: Mar. 23, 2026

Related U.S. Application Data
(60) Provisional application No. 63/776,330, filed on Mar. 24, 2025.

(51) Int. Cl. G06Q 50/12; G06Q 10/04; G06Q 10/0631; G06Q 10/087; G06Q 10/105; G06Q 30/0201; G06Q 30/0282; G06Q 30/0283; G10L 15/22

(52) U.S. Cl. CPC G06Q 50/12; G06Q 10/04; G06Q 10/06315; G06Q 10/08772; G06Q 10/105; G06Q 30/0206; G06Q 30/0282; G06Q 30/0284; G10L 15/22; G10L 2015/223

(57) ABSTRACT

An artificial intelligence-assisted restaurant ordering and management system that automates inventory management, workforce scheduling, menu optimization, and recipe guidance. The system includes a data acquisition subsystem configured to collect operational data including customer orders, inventory sensor data, employee information, and customer feedback. An artificial intelligence processing module analyzes the operational data using machine learning models to generate predictive and prescriptive outputs. An analytics module converts the outputs into operational actions including ingredient replenishment, employee scheduling, and menu modification. A user interface layer presents dashboards, alerts, and voice-based controls, while an external integration module communicates with suppliers and external systems. The system predicts ingredient usage based on menu ordering patterns, generates automated replenishment orders, dynamically optimizes menus, and provides AI-assisted recipe recommendations and step-by-step cooking guidance. The disclosed system reduces waste, improves efficiency, and enhances profitability through continuous, data-driven automation of restaurant operations.

### CROSS-REFERENCE TO RELATED APPLICATION

The present application claims priority to, and the benefit of, U.S. Provisional Application No. 63/776,330 which was filed on Mar. 24, 2025 and is incorporated herein by reference in its entirety.

### FIELD OF THE INVENTION

The present invention generally relates to restaurant management and kitchen automation systems. More specifically, the present invention relates to an artificial intelligence-assisted restaurant ordering and management system configured to automatically manage inventory replenishment, workforce scheduling, menu optimization, and recipe guidance using predictive analytics and machine learning. The invention comprises a system that includes a data acquisition subsystem configured to collect customer order data, inventory sensor data, employee information, and customer feedback. An artificial intelligence processing module is operatively coupled to the data acquisition subsystem and is configured to analyze the collected data to generate predictive and prescriptive outputs. An analytics module converts such outputs into operational actions including automated ingredient reordering, schedule generation, and menu modification. A user interface layer provides dashboards, alerts, and voice-based controls, while an external integration module enables bidirectional communication with suppliers, distributors, and enterprise systems. Accordingly, the present disclosure makes specific reference thereto. Nonetheless, it is to be appreciated that aspects of the present invention are also equally applicable to other like applications, devices, and methods of manufacture.

### BACKGROUND

By way of background, commercial kitchens and restaurant operations frequently experience operational challenges related to employee availability, employee competency, and consistency of service quality. Many restaurants suffer from ongoing labor shortages, high employee turnover, and varying skill levels among kitchen staff. Such conditions often result in increased training burdens, scheduling difficulties, and inconsistent execution of food preparation tasks.

Moreover, errors in order preparation and fulfillment are common in fast-paced kitchen environments. Incorrectly prepared orders may lead to customer dissatisfaction, increased refund or remake costs, and reputational harm. Such errors may arise from miscommunication, inadequate staffing, lack of standardized procedures, or insufficient training.

Additionally, incorrect orders and inefficient preparation frequently result in food waste. Prepared food that does not meet order specifications is often discarded, increasing ingredient costs and negatively impacting profitability. Excessive food waste further contributes to environmental concerns and inefficient use of resources.

Conventional restaurant management systems typically rely on manual processes or static software tools that lack predictive intelligence and real-time optimization capabilities. As a result, existing solutions do not adequately address the combined challenges of workforce shortages, inconsistent execution, order accuracy, and waste reduction. Accordingly, there exists a need for an intelligent, automated system capable of improving operational efficiency, reducing errors, and minimizing waste in commercial kitchen and restaurant environments.

Therefore, there exists a long-felt need in the art for an improved restaurant ordering and management system that overcomes the limitations of conventional manual and static software-based restaurant management solutions. There is a long-felt need in the art for a system that can analyze ordering patterns, inventory consumption, and employee availability to reduce operational inefficiencies. Additionally, there exists a need for a system that minimizes food waste resulting from incorrect orders, inaccurate forecasting, and inefficient inventory replenishment. Moreover, there exists a need for a system that reduces kitchen stress caused by employee shortages, inconsistent skill levels, and frequent scheduling disruptions. Finally, there is a need for an integrated system that automates restaurant logistics so that chefs (i.e., cooks) and staff (i.e., personnel) may focus primarily on food preparation and customer satisfaction.

The subject matter disclosed and claimed herein, in one embodiment, comprises an artificial intelligence-assisted restaurant ordering and management system configured to provide automated inventory management, workforce scheduling, menu optimization, and predictive replenishment. The system includes a data acquisition subsystem configured to collect customer order data, inventory sensor data, employee data, and customer feedback data. An artificial intelligence processing module analyzes the collected data using machine learning models to generate predictive and prescriptive outputs. An analytics module converts such outputs into actionable operational decisions, including automated or approved ingredient reordering, schedule generation, and menu adjustments. A user interface layer provides dashboards, alerts, and voice-based controls for hands-free operation, while an external integration module enables communication with suppliers, distributors, and enterprise systems.

In one embodiment, the system further includes an inventory sensors module comprising barcode scanners, RFID readers, weight sensors, and computer-vision imaging devices configured to monitor inventory levels and movement in real time. The system can further include a workforce scheduling module configured to automatically fill open personnel work shifts by identifying and notifying available part-time or on-call employees. In another embodiment, the system includes a customer intelligence module configured to analyze customer feedback using sentiment analysis and preference modeling to dynamically optimize menu items and pricing.

In this manner, the artificial intelligence-assisted restaurant ordering and management system of the present invention overcomes long-standing deficiencies in the art by providing a unified, intelligent, and automated solution for restaurant operations. The invention reduces food waste, minimizes human error, improves staffing efficiency, enhances customer satisfaction, and increases profitability. The invention further provides scalability, adaptability, and continuous learning capabilities, ensuring that restaurant operations remain efficient, resilient, and competitive in an evolving marketplace.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an artificial intelligence-assisted restaurant ordering and management system that comprises a data acquisition subsystem configured to collect operational data associated with restaurant operations, including customer order data, inventory sensor data, employee data, and customer feedback data. The system further comprises an artificial intelligence (AI) processing module operatively coupled to the data acquisition subsystem and configured to analyze the operational data using one or more machine learning models to generate predictive and prescriptive outputs. The system further comprises an analytics module operatively coupled to the AI processing module and configured to convert the predictive and prescriptive outputs into operational actions including ingredient replenishment actions and workforce scheduling actions. A user interface layer is configured to present operational information and receive user input. An external integration module is configured to communicate with one or more external systems. The system automatically predicts ingredient usage based on menu ordering patterns, generates replenishment orders to minimize waste, and automatically generates and updates employee schedules.

In another embodiment, a computer-implemented method for artificial intelligence-assisted restaurant ordering and management is described. The method comprises receiving customer menu order data and calculating real-time ingredient consumption corresponding to the menu order data, analyzing ordering trends and shelf-life characteristics using an artificial intelligence processing module and predicting replenishment timing and quantities of ingredients. The method further comprises generating an automated or approved reorder of ingredients. The method further comprises receiving employee-related data and predicting staffing requirements. The method further comprises assigning employee shifts based on availability and predicted demand and updating schedules when staffing gaps are detected.

In a further embodiment, the invention provides an artificial intelligence-assisted voice-based reordering system. The system comprises a voice interface module configured to receive spoken commands requesting ingredient replenishment. The system further comprises an AI processing module configured to interpret the spoken commands using natural language processing. The system further comprises an inventory forecasting module configured to verify stock levels and determine reorder requirements. The system further comprises an order management module configured to queue or transmit a reorder based on the spoken command.

In still another embodiment, the data acquisition subsystem includes an inventory sensors module. The inventory sensors module includes at least one of barcode scanners, RFID readers, weight sensors, or computer-vision imaging devices.

In some embodiments, a workforce scheduling module is configured to identify replacement employees when an employee calls off a scheduled shift. The workforce scheduling module automatically updates schedules when a replacement employee accepts an offered shift.

In one aspect, a computer-implemented method for menu optimization using an artificial intelligence-assisted restaurant management system is provided. The method comprises collecting customer feedback data from a plurality of digital and physical channels, analyzing the customer feedback data using one or more artificial intelligence models to identify sentiment, themes, and customer preferences. The method further comprises associating analyzed feedback with corresponding menu items, automatically generating menu modification recommendations based on the analyzed feedback. The menu modification recommendations include at least one of introducing new menu items, removing underperforming menu items, modifying existing menu items, or adjusting pricing.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a functional block diagram view of artificial intelligence-assisted restaurant ordering and management system of the present invention in accordance with the disclosed architecture;

FIG. 2 illustrates a flowchart depicting steps for ingredient usage analysis and predictive replenishment using the artificial intelligence-assisted restaurant ordering and management system of the present invention in accordance with the disclosed architecture;

FIG. 3 illustrates a flowchart depicting steps for workforce scheduling and automatic shift filling using the artificial intelligence-assisted restaurant ordering and management system in accordance with an embodiment of the present invention;

FIG. 4 illustrates a flowchart depicting steps for AI-assisted recipe creation and cooking guidance using the artificial intelligence-assisted restaurant ordering and management system in accordance with an embodiment of the present invention;

FIG. 5 illustrates a flowchart depicting steps for menu optimization using the artificial intelligence-assisted restaurant ordering and management system in accordance with an embodiment of the present invention;

FIG. 6 illustrates a flowchart depicting steps for hands-free voice command reordering using the artificial intelligence-assisted restaurant ordering and management system in accordance with an embodiment of the present invention; and

FIG. 7 illustrates an exemplary graphical user interface dashboard displayed by the artificial intelligence-assisted restaurant ordering and management system in accordance with an embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved restaurant ordering and management system that overcomes the limitations of conventional manual and static software-based restaurant management solutions. There is a long-felt need in the art for a system that can analyze ordering patterns, inventory consumption, and employee availability to reduce operational inefficiencies. Additionally, there exists a need for a system that minimizes food waste resulting from incorrect orders, inaccurate forecasting, and inefficient inventory replenishment. Moreover, there exists a need for a system that reduces kitchen stress caused by employee shortages, inconsistent skill levels, and frequent scheduling disruptions. Finally, there is a need for an integrated system that automates restaurant logistics so that chefs (i.e., cooks) and staff (i.e., personnel) may focus primarily on food preparation and customer satisfaction.

The present invention, in one exemplary embodiment, is a computer-implemented method for artificial intelligence-assisted restaurant ordering and management. The method comprises receiving customer menu order data and calculating real-time ingredient consumption corresponding to the menu order data, analyzing ordering trends and shelf-life characteristics using an artificial intelligence processing module and predicting replenishment timing and quantities of ingredients. The method further comprises generating an automated or approved reorder of ingredients. The method further comprises receiving employee-related data and predicting staffing requirements. The method further comprises assigning employee shifts based on availability and predicted demand and updating schedules when staffing gaps are detected.

Reference will now be made in detail to the present preferred embodiments of the invention, examples of which are illustrated in the accompanying drawings. Wherever possible, the same reference numerals are used in the drawings and the description to refer to the same or like parts.

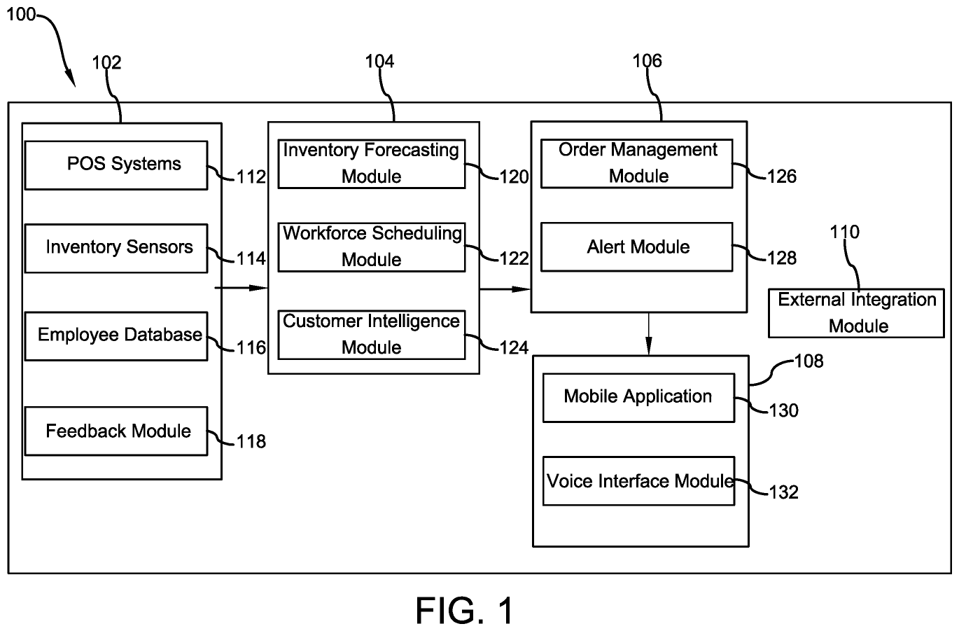

Referring initially to the drawings, FIG. 1 illustrates a functional block diagram view of artificial intelligence-assisted restaurant ordering and management system of the present invention in accordance with the disclosed architecture. The artificial intelligence-assisted restaurant ordering and management system 100 of the present invention is configured as an artificial intelligence-assisted system for automated management of restaurant ordering, inventory management, workforce scheduling, and dynamic pricing to reduce waste, improve efficiency, and maximize profitability. The system 100 comprises a plurality of interconnected subsystems and modules configured to acquire operational data and perform artificial intelligence-based processing to provide actionable outputs to users.

More specifically, the system 100 includes a data acquisition subsystem 102, an AI processing module 104, an analytics module 106, a user interface layer 108, and an external integration module 110. The various subsystems and modules may be implemented using one or more computing devices, servers, cloud-based platforms, or combinations thereof, and may communicate with one another over wired or wireless networks.

The data acquisition subsystem 102 is configured to collect, receive, and aggregate operational data associated with restaurant operations. The operational data collected by the data acquisition subsystem 102 is transmitted to the AI processing module 104 for further analysis. In the illustrated embodiment, the data acquisition subsystem 102 includes a point-of-sale (POS) systems module 112 configured to receive customer order data, transaction records, and menu selections.

An inventory sensors module 114 is configured to automatically and continuously detect, measure, and monitor inventory levels, inventory movement, associated with ingredients, supplies, and prepared items within the restaurant environment. In different embodiments, the inventory sensors module 114 can include one or more barcode scanners, radio-frequency identification (RFID) readers, near-field communication (NFC) devices, weight sensors, optical scanners, and computer-vision imaging devices positioned at storage locations, preparation stations, refrigeration units, and dispensing areas.

Sensor data generated by the inventory sensors module 114 is transmitted in real time or near real time to the data acquisition subsystem 102, where the data is normalized, time-stamped, and associated with specific inventory items. The inventory sensors module 114 enables real time monitoring of stock quantities, detects additions and removals of inventory.

An employee database module 116 is configured to store at least employee profiles, availability information, scheduling history, and skill classifications. The employee database module 116 can further store employee preferences, such as preferred working hours, preferred workstations, and willingness to accept on-call or overtime shifts. The employee database module 116 is configured to receive updates from employees, managers, and external human resource systems through secure interfaces. In some embodiments, employees can update availability, request time off, or accept open personnel work shifts via the mobile application 130 or other user interfaces.

In operation, data maintained within the employee database module 116 is transmitted to the workforce scheduling module 122 of the AI processing module 104, where the data is analyzed to predict staffing requirements, generate optimized schedules, and identify suitable replacement staff when shift gaps occur.

A feedback module 118 is configured to collect and manage customer feedback data from a plurality of digital and physical interaction channels. In various embodiments, the feedback module 118 receives feedback data through mobile applications, web-based interfaces, in-store kiosks, customer surveys, email communications, text messaging platforms, and social media networks.

The feedback module 118 is configured to normalize, time-stamp, and categorize received feedback data and associate such feedback with corresponding menu items, orders, service events, locations, and time periods. Feedback data collected by the feedback module 118 is transmitted to the customer intelligence module 124 of the AI processing module 104, where advanced analytics such as sentiment analysis, topic extraction, keyword identification, and preference modeling are performed.

The AI processing module 104 is configured to apply artificial intelligence and machine learning algorithms to the acquired data in order to generate predictive, prescriptive, and optimization outputs. In one embodiment, the AI processing module 104 includes an inventory forecasting module 120 configured to predict future ingredient usage based on historical ordering patterns, real-time consumption data, seasonal trends, and shelf-life information. The inventory forecasting module 120 may generate short-term and long-term demand forecasts and confidence intervals.

The AI processing module 104 further includes a workforce scheduling module 122 configured to predict staffing requirements, generate employee schedules, and identify replacement staff for open personnel work shifts. Specifically, the workforce scheduling module 122 is configured to receive employee-related data from the employee database module 116 and operational demand data from the data acquisition subsystem 102 and to apply artificial intelligence-based optimization techniques to generate and manage employee or personnel work schedules.

In some embodiments, the workforce scheduling module 122 is configured to determine required staffing levels for different time periods, workstations, and service types based on predicted demand and operational constraints.

The AI processing module 104 also includes a customer intelligence module 124 configured to analyze customer feedback, perform sentiment analysis, and identify customer preferences and menu performance trends.

The analytics module 106 is configured to convert AI-generated outputs into actionable operational decisions and system controls. In the illustrated embodiment, the analytics module 106 includes an order management module 126 configured to generate ingredient replenishment orders, purchase orders, or reorder recommendations, and an alert module 128 configured to generate notifications related to low inventory levels, delivery delays, staffing shortages, equipment status, or other operational conditions. The analytics module 106 communicates with the user interface layer 108 and, in certain embodiments, directly with the external integration module 110.

The user interface layer 108 provides one or more interfaces through which users interact with the system 100. In one embodiment, the user interface layer 108 includes a mobile application 130 configured to present dashboards, alerts, approvals, and operational controls to managers and staff (i.e., personnel). The user interface layer 108 further includes a voice interface module 132 configured to receive spoken commands and provide voice-based confirmations, thereby enabling hands-free operation within a kitchen environment. The user interface layer 108 may additionally include web-based interfaces, touch-screen terminals, or other presentation devices.

In some embodiments, the user interface layer 108 enforces role-based access control. User accounts may be associated with roles such as manager, chef, kitchen staff, or administrator. The system 100 may restrict access to features, approvals, and data based on assigned roles.

The external integration module 110 is configured to enable bidirectional communication between the system 100 and external third-party systems. Such external systems can include ingredient suppliers, distributors, payroll services, accounting platforms, logistics providers, and other enterprise systems. The external integration module 110 can utilize application programming interfaces (APIs), secure data feeds, or other communication protocols to exchange data and execute transactions.

In some embodiments, the AI processing module 104 further includes a dynamic pricing module configured to automatically adjust menu pricing based on demand elasticity, ingredient cost fluctuations, customer sentiment, historical sales performance, and predefined profit margin targets. The dynamic pricing module can analyze time-of-day demand patterns, day-of-week trends, seasonal variations, and promotional activity to determine optimized pricing values. Pricing adjustments generated by the dynamic pricing module may be transmitted to the analytics module 106 and deployed to the POS system 112 and customer-facing menus through the external integration module 110, either automatically or upon managerial approval through the user interface layer 108.

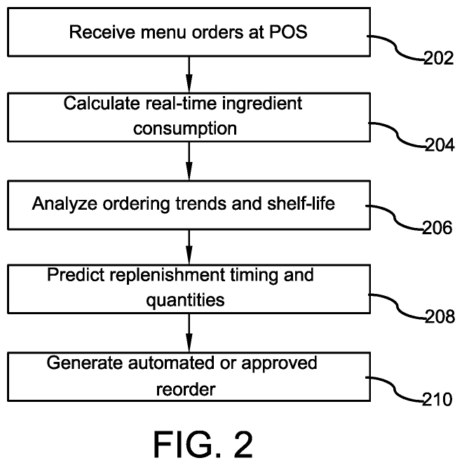

FIG. 2 illustrates a flowchart depicting steps for ingredient usage analysis and predictive replenishment using the artificial intelligence-assisted restaurant ordering and management system of the present invention in accordance with the disclosed architecture. Initially, menu orders are received at the point-of-sale (POS) system 112 (Step 202). Each menu order can include identification of one or more menu items selected by a customer. The received order data is transmitted to the data acquisition subsystem 102 and stored for subsequent processing.

Then, real-time ingredient consumption corresponding to the received order is calculated (Step 204). The system 100 maps each ordered menu item to a predefined recipe or ingredient list and determines corresponding quantities of ingredients consumed. The calculated ingredient usage may be subtracted from current inventory levels derived from the inventory sensors module 114 or from stored inventory records maintained within the system.

Thereafter, ordering trends and shelf-life characteristics are analyzed (Step 206). The AI processing module 104 analyzes historical and current ordering patterns, time-of-day trends, day-of-week trends, seasonal variations, promotional activity, and external factors. The inventory forecasting module 120 further evaluates shelf-life data, expiration dates, storage conditions, and spoilage rates associated with each ingredient to determine remaining usable time.

Then, replenishment timing and quantities of ingredients are predicted based on the ordering trends and shelf-life (Step 208). Based on the analyzed trends, shelf-life data, current stock levels, predicted consumption rates, and supplier lead times, the system generates forecasts indicating when and how much of each ingredient should be reordered in order to maintain desired stock levels while minimizing waste and preventing stock shortages.

Finally, an automated or approved reorder of required ingredients is generated (Step 210). In one embodiment, the system 100 automatically generates a purchase order and transmits the order to a supplier through the external integration module 110. In another embodiment, a reorder recommendation is presented to a manager through the user interface layer 108 for approval prior to execution. The steps of FIG. 2 may be performed continuously or periodically to dynamically adapt to changing operational conditions.

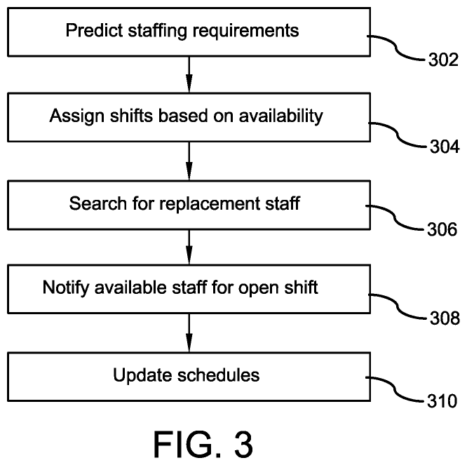

FIG. 3 illustrates a flowchart depicting steps for workforce scheduling and automatic shift filling using the artificial intelligence-assisted restaurant ordering and management system in accordance with an embodiment of the present invention. The method may be executed by one or more components of the system 100, including the data acquisition subsystem 102, the AI processing module 104, the workforce scheduling module 122, the analytics module 106, and the user interface layer 108.

Initially, staffing requirements of a restaurant in which the system 100 is used are predicted (Step 302). The workforce scheduling module 122 can analyze employee-related data received from the employee database module 116, including availability, job roles, skill classifications, certifications, historical schedules, and attendance records. The workforce scheduling module 122 further analyzes predicted customer volume, historical demand patterns, and operational constraints to determine required staffing levels for particular time periods, workstations, and service types.

Then, shifts of employees are assigned based on availability of the employees (Step 304). The workforce scheduling module 122 generates an initial schedule by matching predicted staffing requirements with employee availability and qualifications while satisfying business rules, labor regulations, and budgetary constraints. The generated schedule may be stored within the employee database module 116 and made accessible through the user interface layer 108.

Thereafter, a search for replacement staff is performed (Step 306). The workforce scheduling module 122 monitors schedule adherence and detects staffing gaps caused by employee call-offs, late arrivals, or early departures. Upon detection of a staffing gap, the workforce scheduling module 122 searches the employee database module 116 to identify eligible replacement employees, including part-time or on-call personnel.

At step 308, available staff are automatically notified of an open shift by the alert module 128. The system 100 transmits automated notifications to candidate replacement employees through the user interface layer 108, such as via the mobile application 130, text messages, or other communication channels.

Finally, when a replacement employee accepts an offered shift, the workforce scheduling module 122 automatically updates the schedule within the employee database module 116 (Step 310). The updated schedule may be displayed to managers and staff (i.e., personnel) through the user interface layer 108.

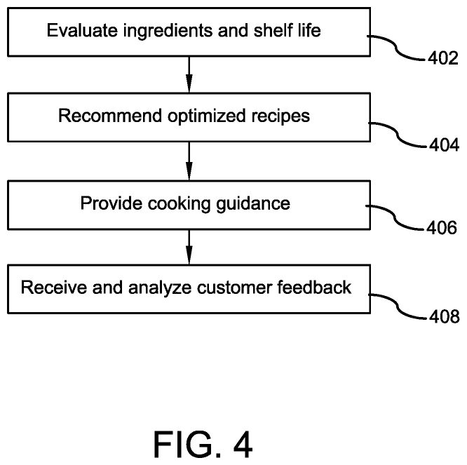

FIG. 4 illustrates a flowchart depicting steps for AI-assisted recipe creation and cooking guidance using the artificial intelligence-assisted restaurant ordering and management system in accordance with an embodiment of the present invention. Initially, registered ingredients and shelf-life thereof are determined and evaluated in the system (Step 402). The inventory forecasting module 120 can analyze current inventory levels received from the inventory sensors module 114 and stored inventory records to determine available ingredients, expiration dates, remaining shelf-life, and storage conditions.

Then, based on determined ingredients and shelf-life optimized recipes are recommended (Step 404). The AI processing module 104 may generate one or more recipe recommendations based on available ingredients, remaining shelf-life, historical menu performance, customer preferences derived from the customer intelligence module 124, and cost considerations. The recommended recipes may be optimized to reduce waste, maximize profitability, and satisfy anticipated customer demand.

At step 406, cooking guidance of the recommended recipes is provided. The system 100 may provide step-by-step cooking instructions, preparation techniques, portion sizes, and plating guidance to kitchen staff via the user interface layer 108, such as through the mobile application 130, monitoring interface, or the voice interface module 132. In some embodiments, the guidance may be adaptive based on staff skill level or available equipment.

Finally, customer feedback on the original and recommended recipes is received and analyzed (Step 408). The feedback module 118 collects customer feedback associated with prepared recipes, and the customer intelligence module 124 can analyze the feedback using sentiment analysis and preference modeling techniques. The analyzed feedback is used to refine future recipe recommendations and cooking guidance.

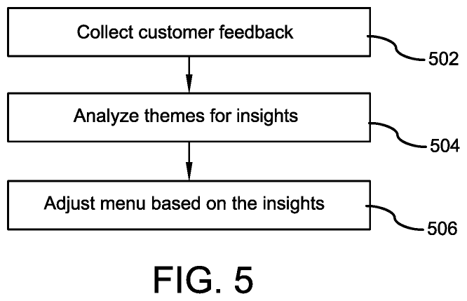

FIG. 5 illustrates a flowchart depicting steps for menu optimization using the artificial intelligence-assisted restaurant ordering and management system in accordance with an embodiment of the present invention. Initially, the feedback module 118 receives structured and unstructured feedback from a plurality of sources, including mobile applications, web-based interfaces, in-store kiosks, surveys, email communications, and social media platforms (Step 502). The feedback can include ratings, comments, reviews, and other qualitative or quantitative information associated with menu items and service experiences of a restaurant in which the system 100 is installed.

Then, the customer intelligence module 124 analyzes the collected feedback using natural language processing, sentiment analysis, and topic extraction techniques to identify recurring themes, customer preferences, and emerging trends (Step 504). The customer intelligence module 124 may associate feedback with specific menu items, time periods, and customer segments.

Based on the insights and trends, the menu of the restaurant is automatically adjusted (Step 506). The analytics module 106 may generate recommendations for modifying menu items, introducing new items, removing underperforming items, or adjusting pricing. In one embodiment, recommended changes are presented to a manager through the user interface layer 108 for approval. In another embodiment, the system 100 automatically deploys approved menu adjustments to the POS system 112 and customer-facing menus.

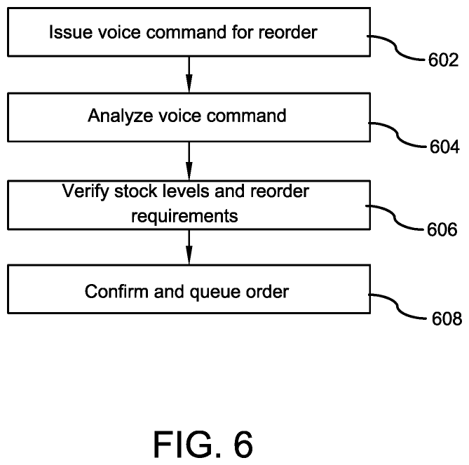

FIG. 6 illustrates a flowchart depicting steps for hands-free voice command reordering using the artificial intelligence-assisted restaurant ordering and management system in accordance with an embodiment of the present invention. At step 602, a voice command for reorder is issued by a restaurant personnel (Step 602). A kitchen staff member or other authorized user may verbally issue a command requesting replenishment of one or more ingredients. The voice interface module 132 can capture the spoken input of the user.

At step 604, the voice command of the user is analyzed. The AI processing module 104 can apply speech-to-text conversion and natural language processing to interpret the spoken command and determine user intent, such as identifying the requested ingredient and quantity.

Then, the inventory forecasting module 120 evaluates current inventory levels received from the inventory sensors module 114 and predicted consumption data to determine whether the reorder indicated in the voice input is required (Step 606). Finally, at step 608, the order is confirmed and queued. The system 100 provides a confirmation to the user via the voice interface module 132 or mobile application 130. The order management module 126 then queues the reorder for automatic execution or managerial approval, depending on system configuration.

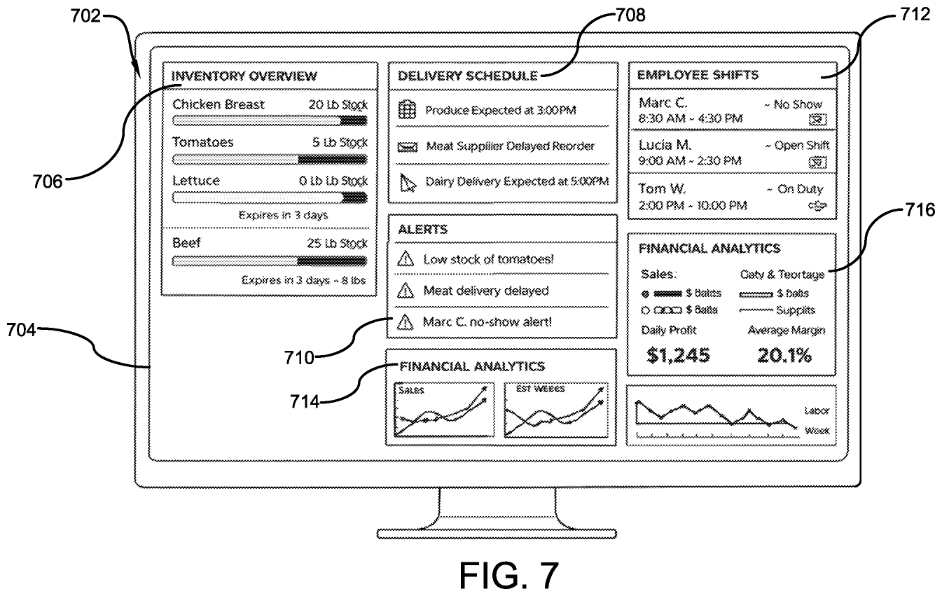

FIG. 7 illustrates an exemplary graphical user interface dashboard displayed by the artificial intelligence-assisted restaurant ordering and management system in accordance with an embodiment of the present invention. The dashboard 704 can be displayed on a computing device, such as a desktop computer, tablet, or mobile device 702. The GUI dashboard 704 may be generated by the user interface layer 108 and presents consolidated operational information produced by the artificial intelligence-assisted restaurant ordering and management system 100.

The GUI dashboard 704 provides a centralized, real-time view of inventory status, delivery schedules, workforce scheduling, alerts, and financial analytics, enabling managers and staff (i.e., personnel) to monitor and control restaurant operations efficiently.

The GUI dashboard 704 includes an inventory overview panel 706 configured to display current inventory levels for one or more ingredients. As shown, the inventory overview panel 706 may display ingredient names, current stock quantities, visual indicators of remaining inventory, and expiration or remaining shelf-life information. Inventory data presented within the inventory overview panel 706 may be derived from the inventory sensors module 114 and inventory forecasting module 120.

The GUI dashboard 704 further includes a delivery schedule panel 708 configured to display upcoming and in-transit deliveries from suppliers. The delivery schedule panel 708 may present expected delivery times, delayed deliveries, and delivery status notifications. Delivery data may be received through the external integration module 110 and processed by the analytics module 106.

The GUI dashboard 704 also includes an employee shifts panel 712 configured to display employee schedules, shift assignments, open personnel work shifts, and attendance status. The employee shifts panel 712 may present employee names, shift times, and status indicators such as “on duty,” “open shift,” or “no show.” Scheduling data may be generated by the workforce scheduling module 122 and stored within the employee database module 116.

An alerts panel 710 is configured to present operational alerts generated by the alert module 128. Alerts can include notifications related to low inventory levels, delayed deliveries, staffing shortages, or other operational conditions requiring attention.

The GUI dashboard 704 further includes one or more financial analytics panels 714 and 716 configured to display financial performance metrics such as sales trends, estimated revenue, cost of goods, labor costs, daily profit, and average profit margin. Financial data may be generated by the analytics module 106 based on operational data and transaction records received from the POS system 112 and external financial systems.

In certain embodiments, the system 100 is configured to support multi-location and franchise management. The data acquisition subsystem 102 may collect operational data from a plurality of restaurant locations, and the AI processing module 104 may generate location-specific and enterprise-level predictions and analytics. The user interface layer 108 may present aggregated and per-location dashboards, enabling centralized oversight and control.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “artificial intelligence-assisted restaurant ordering and management system”, “restaurant ordering and management system”, and “system” are interchangeable and refer to the artificial intelligence-assisted restaurant ordering and management system 100 of the present invention.

Notwithstanding the forgoing, the artificial intelligence-assisted restaurant ordering and management system 100 of the present invention can be of any suitable configuration as is known in the art without affecting the overall concept of the invention, provided that it accomplishes the above stated objectives. One of ordinary skill in the art will appreciate that the artificial intelligence-assisted restaurant ordering and management system 100 shown in the FIGS. are for illustrative purposes only, and that many other configurations of the artificial intelligence-assisted restaurant ordering and management system 100 are well within the scope of the present disclosure. Although the dimensions of the artificial intelligence-assisted restaurant ordering and management system 100 are important design parameters for user convenience, the artificial intelligence-assisted restaurant ordering and management system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An artificial intelligence-assisted restaurant ordering and management system comprising:
a data acquisition subsystem;
an AI processing module;
an analytics module; and
inventory sensors module;
wherein said data acquisition subsystem is configured to collect, receive, and aggregate operational data associated with restaurant operations;
wherein said operational data collected by said data acquisition subsystem is transmitted to said AI processing module;
wherein said data acquisition subsystem comprises a point-of-sale (POS) system module configured to receive one or more selected from the group consisting of customer order data, transaction records, and menu selections;
wherein said inventory sensors module is configured to continuously detect, measure, and monitor inventory data levels and inventory movement;
wherein said inventory data is selected from the group consisting of ingredients, supplies, and prepared items;
wherein said inventory sensors module comprises one or more selected from the group consisting of barcode scanners, radio-frequency identification (RFID) readers, near-field communication (NFC) devices, weight sensors, optical scanners, and computer-vision imaging devices positioned at one or more selected from the group consisting of storage locations, preparation stations, refrigeration units, and dispensing areas;
wherein said inventory data generated by said inventory sensors module is transmitted to said data acquisition subsystem;
wherein said inventory sensors module comprises monitoring of one or more selected from the group consisting of stock quantities of inventory, stock additions to inventory, and stock removals from inventory; and
further wherein said analytics module comprises an order management module configured to generate one or more selected from the group consisting of ingredient replenishment orders, purchase orders, and reorder recommendations.

2. The artificial intelligence-assisted restaurant ordering and management system of claim 1 further comprising an employee database module, wherein said employee database module is configured to store employee data selected from one or more of the group consisting of employee profiles, availability information, scheduling history, and skill classifications.

3. The artificial intelligence-assisted restaurant ordering and management system of claim 2, wherein said employee database module stores said employee data preferences selected from the group consisting of employee preferred working hours, employee preferred workstations, employee acceptance of on-call shifts, and employee acceptance of overtime shifts.

4. The artificial intelligence-assisted restaurant ordering and management system of claim 3, wherein said employee database module is configured to receive updates from one or more of the group consisting of employees, managers, and external human resource systems.

5. The artificial intelligence-assisted restaurant ordering and management system of claim 4, wherein said employee data is analyzed to predict one or more selected from the group consisting of determine staffing requirements, generate optimized schedules, and identify suitable replacement staff when shift gaps occur.

6. The artificial intelligence-assisted restaurant ordering and management system of claim 1 further comprising a feedback module configured to collect and manage customer feedback data from a plurality of digital and physical interaction channels.

7. The artificial intelligence-assisted restaurant ordering and management system of claim 6, wherein said feedback module receives feedback data through one or more selected from the group consisting of mobile applications, web-based interfaces, in-store kiosks, customer surveys, email communications, text messaging platforms, and social media networks.

8. The artificial intelligence-assisted restaurant ordering and management system of claim 7, wherein said feedback module is configured to normalize, time-stamp, and categorize received said feedback data and associate said feedback data with one or more selected from the group consisting of menu items, menu orders, service events, locations, and time periods.

9. The artificial intelligence-assisted restaurant ordering and management system of claim 8, wherein said feedback data collected by said feedback module is transmitted to a customer intelligence module of said AI processing module.

10. The artificial intelligence-assisted restaurant ordering and management system of claim 9, wherein said AI processing module comprises an inventory forecasting module configured to predict future ingredient usage based on one or more selected from the group consisting of historical ordering patterns, real-time consumption data, seasonal trends, and shelf-life information.

11. The artificial intelligence-assisted restaurant ordering and management system of claim 10, wherein said AI processing module comprises a workforce scheduling module configured to predict staffing requirements, generate employee schedules, and identify replacement staff for open personnel work shifts.

12. The artificial intelligence-assisted restaurant ordering and management system of claim 11, wherein said workforce scheduling module is configured to receive employee-related data from said employee database module and operational demand data from said data acquisition subsystem to generate personnel work schedules.

13. The artificial intelligence-assisted restaurant ordering and management system of claim 1 further comprising a customer intelligence module configured to analyze one or more selected from the group consisting of customer feedback, sentiment preferences, customer preference trends, and menu performance trends.

14. An artificial intelligence-assisted restaurant ordering and management system comprising:
a data acquisition subsystem;
an AI processing module;
an analytics module;
an external integration module;
inventory sensors module; and
an alert module;
wherein said data acquisition subsystem is configured to collect, receive, and aggregate operational data associated with restaurant operations;
wherein said operational data collected by said data acquisition subsystem is transmitted to said AI processing module;
wherein said data acquisition subsystem comprises a point-of-sale (POS) system module configured to receive one or more selected from the group consisting of customer order data, transaction records, and menu selections;
wherein said inventory sensors module is configured to continuously detect, measure, and monitor inventory data levels and inventory movement;
wherein said inventory data is selected from the group consisting of ingredients, supplies, and prepared items;
wherein said inventory sensors module comprises one or more selected from the group consisting of barcode scanners, radio-frequency identification (RFID) readers, near-field communication (NFC) devices, weight sensors, optical scanners, and computer-vision imaging devices positioned at one or more selected from the group consisting of storage locations, preparation stations, refrigeration units, and dispensing areas;
wherein said inventory data generated by said inventory sensors module is transmitted to said data acquisition subsystem;
wherein said inventory sensors module comprises monitoring of one or more selected from the group consisting of stock quantities, stock additions, and stock removals of inventory;
wherein said analytics module comprises an order management module configured to generate one or more selected from the group consisting of ingredient replenishment orders, purchase orders, and reorder recommendations; and
further wherein said alert module configured to generate notifications related to one or more selected from the group consisting of low inventory levels, delivery delays, staffing shortages, and equipment status.

15. The artificial intelligence-assisted restaurant ordering and management system of claim 14 further comprising a user interface layer, wherein said user interface layer comprises interfaces through which users interact with the restaurant ordering and management system, further wherein said user interface layer comprises a mobile application configured to present dashboards, alerts, approvals, and operational controls to managers and personnel.

16. The artificial intelligence-assisted restaurant ordering and management system of claim 15, wherein said user interface layer comprises a voice interface module configured to receive spoken commands and to provide voice-based confirmations to enable hands-free operation within a restaurant kitchen environment.

17. The artificial intelligence-assisted restaurant ordering and management system of claim 16, wherein said external integration module is configured for bidirectional communication between the restaurant ordering and management system and external third-party systems, further wherein said external third-party systems comprise one or more selected from the group consisting of ingredient suppliers, distributors, payroll services, accounting platforms, and logistics providers.

18. An artificial intelligence-assisted restaurant ordering and management system comprising:
a data acquisition subsystem;
an AI processing module;
inventory sensors module; and
a dynamic pricing module;
wherein said data acquisition subsystem is configured to collect, receive, and aggregate operational data associated with restaurant operations;
wherein said operational data collected by said data acquisition subsystem is transmitted to said AI processing module;
wherein said data acquisition subsystem comprises a point-of-sale (POS) system module configured to receive one or more selected from the group consisting of customer order data, transaction records, and menu selections;
wherein said inventory sensors module is configured to continuously detect, measure, and monitor inventory data levels and inventory movement;
wherein said inventory data is selected from the group consisting of ingredients, supplies, and prepared items;
wherein said inventory sensors module comprises one or more selected from the group consisting of barcode scanners, radio-frequency identification (RFID) readers, near-field communication (NFC) devices, weight sensors, optical scanners, and computer-vision imaging devices positioned at one or more selected from the group consisting of storage locations, preparation stations, refrigeration units, and dispensing areas;
wherein said inventory data generated by said inventory sensors module is transmitted to said data acquisition subsystem;
wherein said inventory sensors module comprises monitoring of one or more selected from the group consisting of stock quantities, stock additions, and stock removals of inventory;
wherein said dynamic pricing module configured to adjust menu pricing based on one more selected from the group consisting of demand, ingredient cost fluctuations, customer sentiment, historical sales performance, and predefined profit margin targets; and
further wherein said AI processing module comprises an inventory module configured to track ingredient usage based on one or more selected from the group consisting of real-time consumption data, shelf-life information, ordered menu items, and predefined ingredient lists of said ordered menu items.

19. The artificial intelligence-assisted restaurant ordering and management system of claim 18, wherein said dynamic pricing module analyzes one or more selected from the group consisting of time-of-day demand patterns, day-of-week trends, seasonal variations, and promotional activity to determine said menu pricing.

20. The artificial intelligence-assisted restaurant ordering and management system of claim 18 further comprising a user interface layer, wherein said user interface layer comprises a voice interface module configured to receive spoken commands and to provide voice-based confirmations to enable hands-free operation within a restaurant kitchen environment.
